(19) United States
(12) Patent Application Publication
(10) Pub. No.: US 2016/0212069 A1
(43) Pub. Date: Jul. 21, 2016

(54) COOPERATIVE MANAGEMENT OF CLIENT DEVICE CACHE MEMORY IN AN HTTP SESSION

(71) Applicant: QUALCOMM Incorporated, San Diego, CA (US)

(72) Inventors: Noam Cohen, Kerem Maharal (IL); Valeriya Perelman, Nesher (IL)

(21) Appl. No.: 14/801,926

(22) Filed: Jul. 17, 2015

Related U.S. Application Data
(60) Provisional application No. 62/105,853, filed on Jan. 21, 2015.

(51) Int. Cl. H04L 12/861; H04L 29/06; H04L 29/08

(52) U.S. Cl. CPC H04L 49/90; H04L 67/02; H04L 67/42; H04L 67/10

(57) ABSTRACT

A method of cooperative management of cache memory of a client device in a Hypertext Transfer Protocol (HTTP) session includes receiving an HTTP request at a server from the client device for a first resource. The HTTP request includes identification meta-data to identify at least one second resource that is contained in the cache memory of the client device. The method also includes determining, by the server, whether the at least one second resource identified in the identification meta-data of the HTTP request should be evicted from the cache memory of the client device. The server then sends an HTTP response to the client device, where the HTTP response indicates to the client device to evict the at least one second resource from the cache memory of the client device in response to determining that the at least one second resource should be evicted.

### CROSS-REFERENCE TO RELATED APPLICATION

The present Application for Patent claims the benefit of U.S. Provisional Application No. 62/105,853, entitled “CLIENT-SERVER COOPERATIVE CACHE MANAGEMENT,” filed Jan. 21, 2015, assigned to the assignee hereof, and expressly incorporated herein by reference in its entirety.

### FIELD OF DISCLOSURE

Aspects of this disclosure relate generally to client-server communication in an HTTP session and more particularly, to the management of cache memory of a client device in an HTTP session.

### BACKGROUND

Web browsers are applications that typically are executed on a client device (e.g., personal computer or mobile device) that allows a user of the client device to view or download resources that are available on a network, such as on a website on the World Wide Web. Utilizing a protocol, such as Hypertext Transfer Protocol (HTTP), a web browser may establish an HTTP session with a web server to retrieve, access and/or view resources. Resources may include both information resources (e.g., passive content such as text, images, videos) and ‘active’ resources (e.g., scripts such as JAVASCRIPT).

Web browsers typically include a browser cache memory that utilizes cache memory resources of the client device. The cache memory is a collection of resources, previously obtained by the web browser, that may be duplicates of resources stored elsewhere (e.g., on the network, or on the web server). The original resources may be too expensive to fetch from the original location when compared to the cost of reading the resource from the local browser cache memory. Thus, browser cache memory may improve the performance of the web browser. That is, interaction with resources for rendering a web site is most effective when the process is responsive (e.g., retrieval of the resource occurs with limited ‘lag’ or delay between request and display). In some cases, a user interface of a browser may become unresponsive due to improper rendering of content for display. A browser's user interface may also become unresponsive if it is waiting for content to be rendered for display. Browser cache memories may be used to reduce the lag of resource presentation and otherwise improve the performance of a web browser.

### SUMMARY

Embodiments of the present disclosure are directed methods, client devices, and server devices that are configured to support the cooperative management of cache memory of a client device in a Hypertext Transfer Protocol (HTTP) session.

In one aspect, a method of cooperative management of cache memory of a client device in a Hypertext Transfer Protocol (HTTP) session includes receiving an HTTP request at a server from the client device for a first resource. The HTTP request includes identification meta-data to identify at least one second resource that is contained in the cache memory of the client device. The method also includes determining, by the server, whether the at least one second resource identified in the identification meta-data of the HTTP request should be evicted from the cache memory of the client device. The server then sends an HTTP response to the client device, where the HTTP response indicates to the client device to evict the at least one second resource from the cache memory of the client device in response to determining that the at least one second resource should be evicted.

According to another aspect, a method of cooperative management of cache memory of a client device in an HTTP session includes generating an HTTP request, at the client device, for a first resource. The HTTP request includes identification meta-data to identify at least one second resource that is contained in the cache memory of the client device. The method also includes sending the HTTP request to a server and receiving an HTTP response from the server in response thereto. The client device then determines whether the HTTP response indicates that the at least one second resource should be evicted from the cache memory of the client device and, if so, evicts the at least one second resource from the cache memory of the client device.

In yet another aspect, a web server for cooperative management of cache memory of a client device in a Hypertext Transfer Protocol (HTTP) session includes memory adapted to store program code and a processing unit coupled to the memory to access and execute instructions included in the program code. The instructions direct the web server to: (1) receive an HTTP request at the web server from the client device for a first resource, where the HTTP request includes identification meta-data to identify at least one second resource that is contained in the cache memory of the client device; (2) determine, by the web server, whether the at least one second resource identified in the identification meta-data of the HTTP request should be evicted from the cache memory of the client device; and (3) send an HTTP response to the client device, where the HTTP response indicates to the client device to evict the at least one second resource from the cache memory of the client device in response to determining that the at least one second resource should be evicted.

In still another aspect, a client device is provided for cooperative management of cache memory of the client device in a Hypertext Transfer Protocol (HTTP) session with a web server. The client device includes memory adapted to store program code and a processing unit coupled to the memory to access and execute instructions included in the program code. The instructions direct the client device to: (1) generate an HTTP request, at the client device, for a first resource, where the HTTP request includes identification meta-data to identify at least one second resource that is contained in the cache memory of the client device; (2) send the HTTP request to the web server; (3) receive an HTTP response from the web server; (4) determine whether the HTTP response indicates that the at least one second resource should be evicted from the cache memory of the client device; and (5) evict the at least one second resource from the cache memory of the client device in response to determining that the HTTP response indicates that the at least one second resource should be evicted.

In one aspect, a web server is provided for cooperative management of cache memory of the client device in a Hypertext Transfer Protocol (HTTP) session with a web server. The web server includes means for receiving an HTTP request at the web server from the client device for a first resource. The HTTP request includes identification meta-data to identify at least one second resource that is contained in the cache memory of the client device. The web server also includes means for determining, by the web server, whether the at least one second resource identified in the identification meta-data of the HTTP request should be evicted from the cache memory of the client device. The web server further includes means for sending an HTTP response to the client device, where the HTTP response indicates to the client device to evict the at least one second resource from the cache memory of the client device in response to determining that the at least one second resource should be evicted.

According to another aspect, a client device is provided for cooperative management of cache memory of the client device in a Hypertext Transfer Protocol (HTTP) session with a web server. The client device includes means for generating an HTTP request, at the client device, for a first resource. The HTTP request includes identification meta-data to identify at least one second resource that is contained in the cache memory of the client device. The client device also includes means for sending the HTTP request to the web server and means for receiving an HTTP response from the web server in response thereto. The client device further includes means for determining whether the HTTP response indicates that the at least one second resource should be evicted from the cache memory of the client device and, if so, means for evicting evicts the at least one second resource from the cache memory of the client device.

In yet another aspect, a non-transitory computer-readable medium for cooperative management of cache memory of the client device in a Hypertext Transfer Protocol (HTTP) session includes at least one instruction to: (1) receive an HTTP request at the web server from the client device for a first resource, where the HTTP request includes identification meta-data to identify at least one second resource that is contained in the cache memory of the client device; (2) determine, by the web server, whether the at least one second resource identified in the identification meta-data of the HTTP request should be evicted from the cache memory of the client device; and (3) send an HTTP response to the client device, where the HTTP response indicates to the client device to evict the at least one second resource from the cache memory of the client device in response to determining that the at least one second resource should be evicted.

In still another aspect, a non-transitory computer-readable medium for cooperative management of cache memory of the client device in a Hypertext Transfer Protocol (HTTP) session includes at least one instruction to: (1) generate an HTTP request, at the client device, for a first resource, where the HTTP request includes identification meta-data to identify at least one second resource that is contained in the cache memory of the client device; (2) send the HTTP request to the web server; (3) receive an HTTP response from the web server; (4) determine whether the HTTP response indicates that the at least one second resource should be evicted from the cache memory of the client device; and (5) evict the at least one second resource from the cache memory of the client device in response to determining that the HTTP response indicates that the at least one second resource should be evicted.

In one aspect, a method of cooperative management of cache memory of a client device in a Hypertext Transfer Protocol (HTTP) session includes receiving an HTTP request at a server from the client device for a first resource. The HTTP request includes identification meta-data to identify at least one second resource that is contained in the cache memory of the client device. The at least one second resource includes a content component and a meta-data component. The method also includes determining, by the server, whether the meta-data component of the at least one second resource identified in the identification meta-data of the HTTP request should be updated in the cache memory of the client device. The server then sends an HTTP response to the client device, where the HTTP response indicates to the client device to update the meta-data component of the at least one second resource in the cache memory of the client device in response to determining that the meta-data component of the at least one second resource should be updated.

According to another aspect, a method of cooperative management of cache memory of a client device in an HTTP session includes generating an HTTP request, at the client device, for a first resource. The HTTP request includes identification meta-data to identify at least one second resource that is contained in the cache memory of the client device. The at least one second resource includes a content component and a meta-data component. The method also includes sending the HTTP request to a server and receiving an HTTP response from the server in response thereto. The client device then determines whether the HTTP response indicates that the meta-data component of the at least one second resource should be updated in the cache memory of the client device and, if so, updates the meta-data component.

In yet another aspect, a web server for cooperative management of cache memory of a client device in a Hypertext Transfer Protocol (HTTP) session includes memory adapted to store program code and a processing unit coupled to the memory to access and execute instructions included in the program code. The instructions direct the web server to: (1) receive an HTTP request at the web server from the client device for a first resource, where the HTTP request includes identification meta-data to identify at least one second resource that is contained in the cache memory of the client device, and where the at least one second resource includes a content component and a meta-data component; (2) determine, by the web server, whether the meta-data component of the at least one second resource identified in the identification meta-data of the HTTP request should updated in the cache memory of the client device; and (3) send an HTTP response to the client device, where the HTTP response indicates to the client device to update the meta-data component of the at least one second resource in the cache memory of the client device.

In still another aspect, a client device is provided for cooperative management of cache memory of the client device in a Hypertext Transfer Protocol (HTTP) session with a web server. The client device includes memory adapted to store program code and a processing unit coupled to the memory to access and execute instructions included in the program code. The instructions direct the client device to: (1) generate an HTTP request, at the client device, for a first resource, where the HTTP request includes identification meta-data to identify at least one second resource that is contained in the cache memory of the client device, and where the at least one second resource includes a content component and a meta-data component; (2) send the HTTP request to the web server; (3) receive an HTTP response from the web server; (4) determine whether the HTTP response indicates that the meta-data component of the at least one second resource should be updated in the cache memory of the client device; and (5) update the meta-data component of the at least one second resource in the cache memory of the client device in response to determining that the HTTP response indicates that the meta-data component of the at least one second resource should be updated.

In one aspect, a web server is provided for cooperative management of cache memory of the client device in a Hypertext Transfer Protocol (HTTP) session with a web server. The web server includes means for receiving an HTTP request at the web server from the client device for a first resource. The HTTP request includes identification meta-data to identify at least one second resource that is contained in the cache memory of the client device, where the at least one second resource includes a content component and a meta-data component. The web server also includes means for determining, by the web server, whether the meta-data component of the at least one second resource identified in the identification meta-data of the HTTP request should be updated in the cache memory of the client device. The web server further includes means for sending an HTTP response to the client device, where the HTTP response indicates to the client device to update the meta-data component of the at least one second resource in the cache memory of the client device.

According to another aspect, a client device is provided for cooperative management of cache memory of the client device in a Hypertext Transfer Protocol (HTTP) session with a web server. The client device includes means for generating an HTTP request, at the client device, for a first resource. The HTTP request includes identification meta-data to identify at least one second resource that is contained in the cache memory of the client device, where the at least one second resource includes a content component and a meta-data component. The client device also includes means for sending the HTTP request to the web server and means for receiving an HTTP response from the web server in response thereto. The client device further includes means for determining whether the HTTP response indicates that the meta-data component of the at least one second resource should be updated in the cache memory of the client device and, if so, means for updating updates the meta-data component of the at least one second resource in the cache memory of the client device.

In yet another aspect, a non-transitory computer-readable medium for cooperative management of cache memory of the client device in a Hypertext Transfer Protocol (HTTP) session includes at least one instruction to: (1) receive an HTTP request at the web server from the client device for a first resource, where the HTTP request includes identification meta-data to identify at least one second resource that is contained in the cache memory of the client device, and where the at least one second resource includes a content component and a meta-data component; (2) determine, by the web server, whether the meta-data component of the at least one second resource identified in the identification meta-data of the HTTP request should be updated in the cache memory of the client device; and (3) send an HTTP response to the client device, where the HTTP response indicates to the client device to update the meta-data component of the at least one second resource in the cache memory of the client device in response to determining that the at least one second resource should be updated.

In still another aspect, a non-transitory computer-readable medium for cooperative management of cache memory of the client device in a Hypertext Transfer Protocol (HTTP) session includes at least one instruction to: (1) generate an HTTP request, at the client device, for a first resource, where the HTTP request includes identification meta-data to identify at least one second resource that is contained in the cache memory of the client device, and where the at least one second resource includes a content component and a meta-data component; (2) send the HTTP request to the web server; (3) receive an HTTP response from the web server; (4) determine whether the HTTP response indicates that the meta-data component of the at least one second resource should be updated in the cache memory of the client device; and (5) update the meta-data component of the at least one second resource in the cache memory of the client device in response to determining that the HTTP response indicates that meta-data component should be updated.

### BRIEF DESCRIPTION OF THE DRAWINGS

The accompanying drawings are presented to aid in the description of various aspects of the disclosure and are provided solely for illustration of the aspects and not limitation thereof.

FIG. 1 is a functional block diagram illustrating an example HTTP session between a client device and a web server via a network.

FIG. 2 is a functional block diagram illustrating further details of an example client device and an example web server.

FIG. 3 is a flowchart illustrating an example process, performed by a server, of cooperative management of cache memory of a client device in an HTTP session.

FIG. 4 is a flowchart illustrating an example process, performed by a client device, of cooperative management of cache memory of the client device in an HTTP session.

FIGS. 5A-5D illustrate various optional processes, performed by a server, for cooperative management of cache memory of a client device in an HTTP session.

FIGS. 6A-6C illustrate various optional processes, performed by a client device, for cooperative management of cache memory of a client device in an HTTP session.

FIG. 7 is a simplified block diagram illustrating several sample aspects of components that may be employed in web server apparatus configured to support cooperative management of cache memory of a client device in an HTTP session.

FIG. 8 is a simplified block diagram illustrating several sample aspects of components that may be employed in a client device apparatus configured to support cooperative management of cache memory of the client device in an HTTP session.

FIG. 9 is an example server configured to support cooperative management of cache memory of the client device in an HTTP session.

FIG. 10 is an example message flow procedure between a client device and a web server in an HTTP session for cooperative management of cache memory of the client device.

### DETAILED DESCRIPTION

As mentioned above, the utilization of cache memory to store resources by a web browser may improve the performance of the web browser. With the advent of the HTTP/2 protocol, web servers are provided with the capability to push resources to a client device pro-actively (i.e., independent of an explicit request for that resource). This capability of a web-server to pro-actively push resources to a client device may allow the web server to provide required resources to the client device earlier in the HTTP session. For example, a typical process of a client device browsing to a web site may include getting from a web server (via HTTP/2) a main HTML resource and then processing the received main HTML resource. Processing of the main HTML resource may reveal additional resources needed by the client device in order to render the desired web page. Thus, the pro-active pushing of resources by a web server, via HTTP/2, may allow the web server to provide these additional resources to the client device even before the client device begins (or completes) processing of the main HTML resource.

However, conventional web server implementations are not aware of which resources are already present in the client device's cache memory, and, as such, conventional pushing of resources by these web servers is sub-optimal. For example, without knowledge of the contents of the client device cache memory, a web server may send resources already contained in the cache memory of the client device, thus, wasting network bandwidth. Furthermore, the cache memory of the client device may contain obsolete resources, that unbeknown to the client device, are no longer relevant. Even still the client device may have to spend time to parse and revalidate resources contained in the cache memory that should be updated.

Accordingly, embodiments discussed herein provide for the cooperative management of cache memory of the client device in a Hypertext Transfer Protocol (HTTP) session between the client device and a server (e.g., web server). As will be discussed in more detail below, embodiments discussed herein may allow for a client device to share relevant data about the contents of its cache memory to allow the server to aide in the management of the client device's cache memory. In one aspect, the server may provide an indication to the client device to evict one or more resources contained in the cache memory of the client device. In another aspect, the server may push only those resources to the client device that are not already included in the cache memory of the client device. In yet another aspect, the server may determine that one or more of the resources contained in the cache memory of the client device need to be updated and then push only those resources that need to be updated to the client device. In even another aspect, the server may determine that a meta-data component of one or more resources contained in the cache memory of the client device needs to be updated, and then send an indication to the client device to update only those meta-data components.

More specific aspects of the disclosure are provided in the following description and related drawings directed to various examples provided for illustration purposes. Alternate aspects may be devised without departing from the scope of the disclosure. Additionally, well-known aspects of the disclosure may not be described in detail or may be omitted so as not to obscure more relevant details.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., Application Specific Integrated Circuits (ASICs)), by program instructions being executed by one or more processors, or by a combination of both. In addition, for each of the aspects described herein, the corresponding form of any such aspect may be implemented as, for example, “logic configured to” perform the described action.

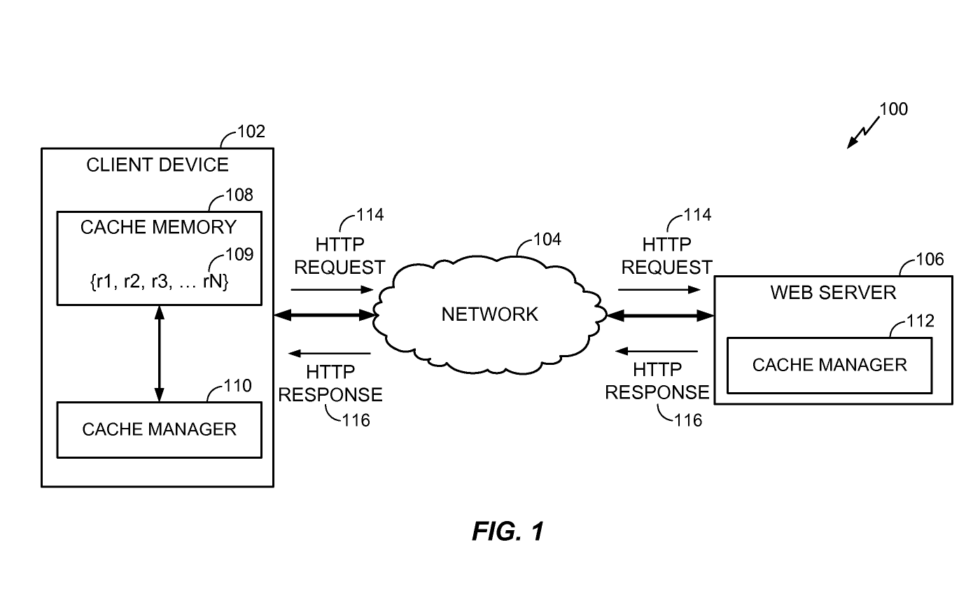

FIG. 1 is a functional block diagram illustrating an example HTTP session 100 between a client device 102 and a web server 106 via a network 104. The illustrated example of client device 102 includes cache memory 108 coupled to cache manager 110. Included in cache memory 108 is a set of resources 109 containing one or more resources (e.g., r1, r2, r3, . . . rN). In one embodiment, the resources r1, r2, r3, . . . , rN may include one or more of a web page, text, an image, or a video. The illustrated example of web server 106 is shown as including a cache manager 112.

Client device 102 may be any device, including a wireless communication device, a mobile device, a laptop computer, a desktop computer, a personal digital assistant (PDA), a digital audio player (e.g., MP3 player), a camera, a game console, a display device, etc., which is capable of communication with a server (e.g., web server 106), either directly or via a network 104 (e.g., the Internet, WiFi, or other network). Similarly, web server 106 may be any device, including a wireless communication device, a mobile device, a laptop computer, a desktop computer, a personal digital assistant (PDA), a digital audio player (e.g., MP3 player), a camera, a game console, a display device, etc., which is capable of communication with a client device (e.g., client device 102), either directly or via network 104. Although, FIG. 1 illustrates a single client device 102, web server 106 may support any number of client devices for providing one or more web services. Client device 102 and web server 106 may employ a variety of widely used networking protocols to establish the HTTP session 100 between the client device 102 and web server 106. In one example, client device 102 and web server 106 employ the HTTP/2 protocol to establish and maintain the HTTP session 100.

In one example, web server 106 is a stateless web server. That is, a stateless web server may be a web server that treats each request as an independent transaction that is unrelated to any previous request so that the communication consists of independent pairs of one request and one response. In one embodiment, a stateless web server does not retain session information or a status about each communications partner for the duration of multiple requests. HTTP and HTTP/2 are examples of stateless protocols that may be implemented by web server 106.

In operation, client device 102 may include a web browser (not shown) which includes a set of resources 109 stored in cache memory 108 of the client device 102. The client device 102 may then generate an HTTP request 114 for a first resource that is not already included in the set of resources 109. For example, the first resource may include a main HTML resource for a web page not already stored in cache memory 108. Furthermore, the generated HTTP request 114 also includes identification meta-data that identifies one or more second resources that are already contained in cache memory 108. Thus, the HTTP request 114 is a request for a resource not included in the set of resources 109, but does include identification meta-data identifying one or more of the resources 109 that are indeed included in the set of resource 109. In one embodiment, the HTTP request 114 is an HTTP GET message. Thus, the identification meta-data may be meta-data included with the HTTP GET message.

Client device 102 then sends the HTTP request 114 to web server 106 via network 104. Upon receipt of the HTTP request 114 at web server 106, cache manager 112 may determine whether the HTTP request 114 includes the identification meta-data. If so, cache manager 112 may generate an HTTP response 116. In one embodiment, the cache manager 112 generates to the HTTP response 116 to indicate to the client device to evict one or more resources 109 contained in the cache memory 108. In another aspect, the cache manager 112 may push additional resources to the client device 102 that are not already included in the cache memory 108. In yet another aspect, the cache manager 112 may determine that one or more of the resources 109 contained in the cache memory 108 need to be updated and then push only those resources that need to be updated to the client device 102. In even another aspect, the cache manager 112 may determine that a meta-data component of one or more resources 109 contained in the cache memory 108 needs to be updated, and then send the HTTP response 116 to indicate to the client device to update only those meta-data components. In one embodiment, sending the HTTP response 116 by web server 106 includes sending an appended HTTP header to the client device that provides the desired indication (e.g., which resources to evict, which resources to update, etc.).

The HTTP response 116 is then received at client device 102 via network 104. Upon receipt of the HTTP response 116, cache manager 110 then determines whether the HTTP response 116 includes an indication from the web server 106 having to do with the management of cache memory 108. If so, cache manager 110 may then perform management of the cache memory 108 with the assistance of the information provided in the HTTP response 116. For example, if HTTP response 116 indicates that one or more of the resources 109 contained in cache memory 108 should be evicted, cache manager 110 may then evict those resources. In another example, if the HTTP response 116 indicates that one or more of the resources 109 should be updated, the cache manager 110 may then update only those resources 109.

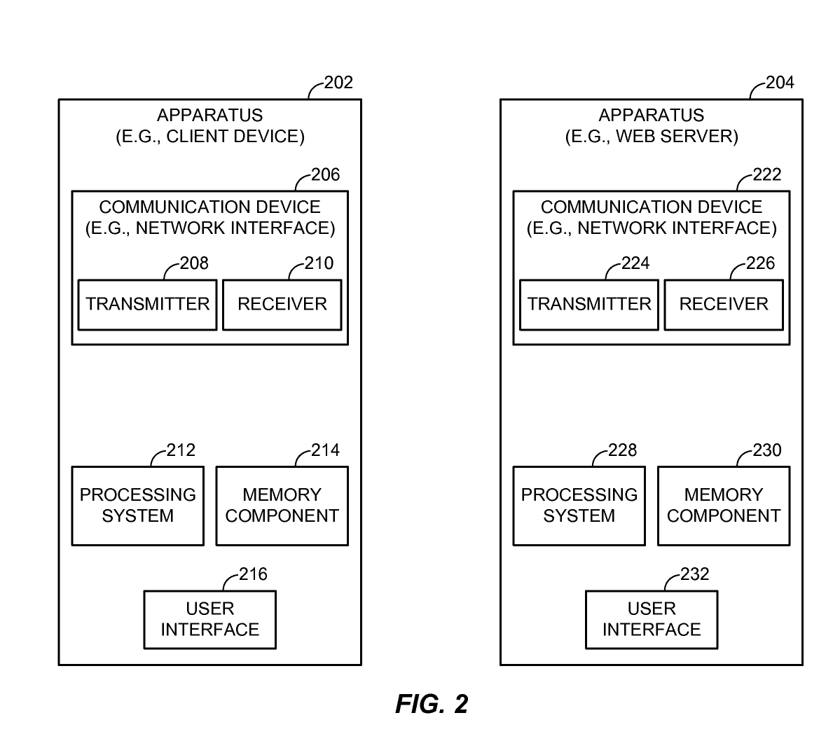

FIG. 2 is a functional block diagram illustrating further details of an example apparatus 202 and an example apparatus 204. Client device 202 is one possible implementation of client device 102 and web server 204 is one possible implementation of web server 106, both of FIG. 1.

FIG. 2 illustrates several sample components (represented by corresponding blocks) that may be incorporated into an apparatus 202 and an apparatus 204 (corresponding to, for example, a client device and a web server, respectively) to support the cooperative management of cache memory of a client device in an HTTP session, as taught herein. It will be appreciated that these components may be implemented in different types of apparatuses in different implementations (e.g., in an ASIC, in an SoC, etc.). The illustrated components may also be incorporated into other apparatuses in a communication system. For example, other apparatuses in a system may include components similar to those described to provide similar functionality. Also, a given apparatus may contain one or more of the components. For example, an apparatus may include communication device components that enable the apparatus to operate on networks and/or communicate via different technologies.

The apparatus 202 and the apparatus 204 each include at least one communication device (represented by the communication device 206 and 222, respectively) for communicating with other nodes. For example, the communication device 206 may comprise a network interface that is configured to communicate with one or more network entities via a wire-based or wireless connection. In some aspects, the communication device 206 may be implemented as a transceiver configured to support wire-based or wireless signal communication. This communication may involve, for example, sending and receiving: messages, parameters, or other types of information. Accordingly, in the example of FIG. 2, the communication device 206 is shown as comprising a transmitter 208 and a receiver 210. Similarly, communication device 222 may comprise a network interface that is configured to communicate with one or more network entities via a wire-based or wireless connection. As with the communication device 206, the communication device 222 is shown as including a transmitter 224 and a receiver 226.

The apparatuses 202 and 204 also include other components that may be used to support the cooperative management of cache memory of a client device in an HTTP session, as taught herein. The apparatus 202 includes a processing system 212 for providing functionality relating to, for example, cache manager 110, as discussed above with reference to FIG. 1, as well as for providing other processing functionality. The apparatus 204 includes a processing system 228 for providing functionality relating to, for example, cache manager 112 as discussed above with reference to FIG. 1, as well as for providing other processing functionality. The apparatus 202 includes memory component 214 for providing functionality relating to, for example, cache memory 108 as discussed above with reference to FIG. 1, as well as for providing other memory functionality (e.g., for storing instructions and maintaining information, such as thresholds, parameters, and so on). Similarly, apparatus 204 includes memory component 230 for maintaining instructions and/or information related to the operation of apparatus 204. In addition, the apparatuses 202 and 204 include user interface devices 216 and 232, respectively, for providing indications (e.g., audible and/or visual indications) to a user and/or for receiving user input (e.g., upon user actuation of a sensing device such a keypad, a touch screen, a microphone, and so on). In one example, user interface 216 provides rendering of a web page to a user by a web browser based on one or more of the resources 109.

For convenience, the apparatuses 202 and 204 are shown in FIG. 2 as including various components that may be configured according to the various examples described herein. It will be appreciated, however, that the illustrated blocks may have different functionality in different designs.

The components of FIG. 2 may be implemented in various ways. In some implementations, the components of FIG. 2 may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 206, 212, 214, and 216 may be implemented by processor and memory component(s) of the apparatus 202 (e.g., by execution of appropriate code and/or by appropriate configuration of processor components). Similarly, some or all of the functionality represented by blocks 222, 228, 230, and 232 may be implemented by processor and memory component(s) of the apparatus 204 (e.g., by execution of appropriate code and/or by appropriate configuration of processor components).

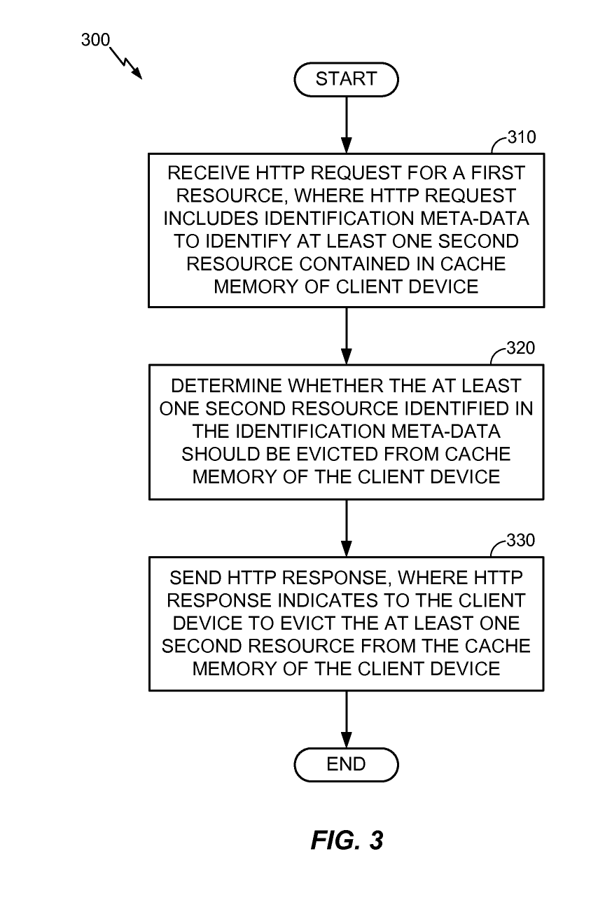

FIG. 3 is a flowchart illustrating an example process 300, performed by a server (e.g., web server 106 and/or web server 204), of cooperative management of cache memory of a client device in an HTTP session 100.

In process block 310, a web server 106 receives an HTTP request 114 from a client device 102 for a first resource. As discussed above, the first resource may be a resource not already included in cache memory 108 of the client device 102, such as a main HTML resource (e.g., a web page). The HTTP request 114 also includes identification meta-data to identify at least one second resource 109 that is contained in the cache memory 108 of the client device 102. Next, in process block 320, the web server 106 determines whether the at least one second resource 109 identified in the identification meta-data of the HTTP request 114 should be evicted from the cache memory 108 of the client device. In one embodiment, web server 106 determines whether the at least one second resource 109 should be evicted from cache memory 108 based on information that is not directly accessible to the client device 102.

Process 300 then continues to process block 330, where web server 106 generates and sends an HTTP response 116 to the client device 102. The HTTP response 116 sent in process block 330 indicates to the client device 102 to evict the at least one second resource 109 from the cache memory 108 of the client device 102. As discussed above, the HTTP response 116 may be an appended HTTP header that indicates which of the resources 109 to evict from cache memory 108.

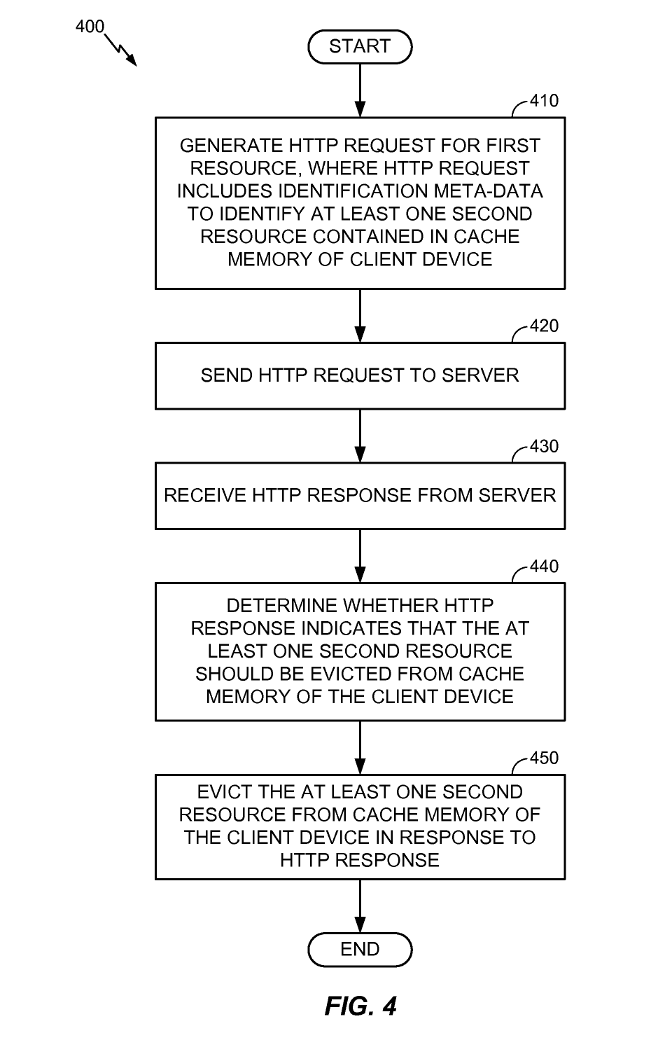

FIG. 4 is a flowchart illustrating an example process 400, performed by a client device (e.g., client device 102 and/or client device 202), of cooperative management of cache memory of the client device 102 in an HTTP session 100.

In a process block 410, the client device 102 generates an HTTP request 114 for a first resource. As discussed above, the first resource may be a resource not already included in cache memory 108 of the client device 102, such as a main HTML resource (e.g., a web page). The HTTP request 114 also includes identification meta-data to identify at least one second resource 109 that is contained in the cache memory 108 of the client device 102. In one embodiment, the identification meta-data included in the HTTP request 114 provides an identification of every resource 109 included in cache memory 108. In another embodiment, the identification meta-data included in the HTTP request 114 provides an indication of a subset of the resources 109 included in cache memory 108. In one example, the identification meta-data identifies resources includes in the cache memory 108 by way of one or more Universal Resource Indicator (URIs) included in the meta data of an HTTP GET message.

In process block 420, client device 102 sends the HTTP request 114 to the web server 106. In response to sending the HTTP request 114, client device 102 then receives an HTTP response 116 from the web server 106 in process block 430. In process block 440, the client device 102 then determines whether the HTTP response 116 indicates that the at least one second resource 109 should be evicted from the cache memory 108. As mentioned above, the HTTP response 116 may be received by way of an appended HTTP header. Thus, determining which resources to evict from cache memory 108 may include examining the HTTP header that is returned in response to the HTTP request. Next, in process block 450, if the HTTP response 116 indicates one or more resources to evict, then client device 102 proceeds with evicting the at least one second resource from the cache memory 108. In one embodiment, evicting a resource from cache memory 108 may include deleting or otherwise removing the resource from cache memory 108.

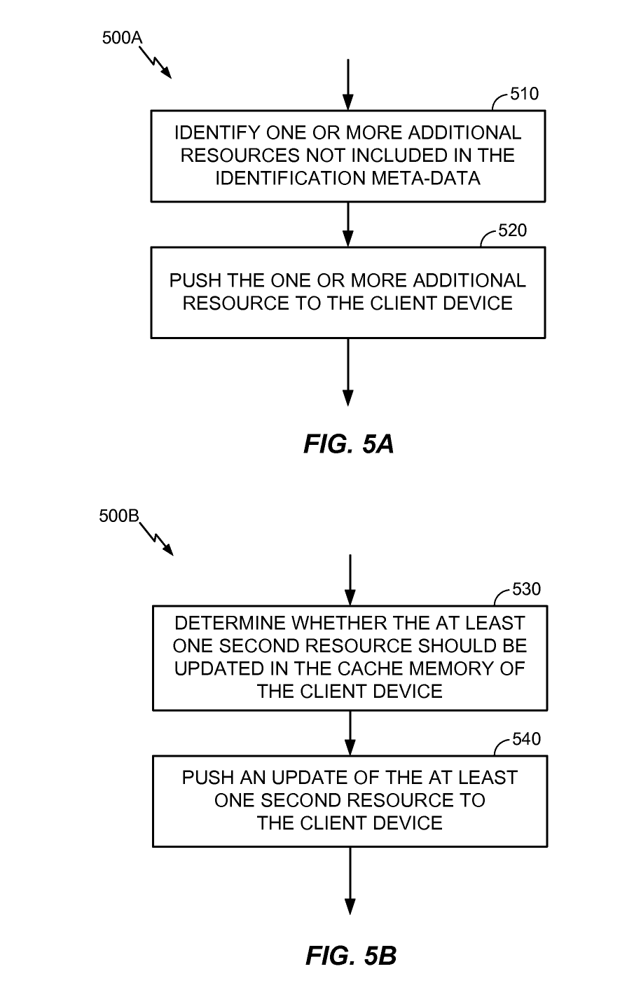

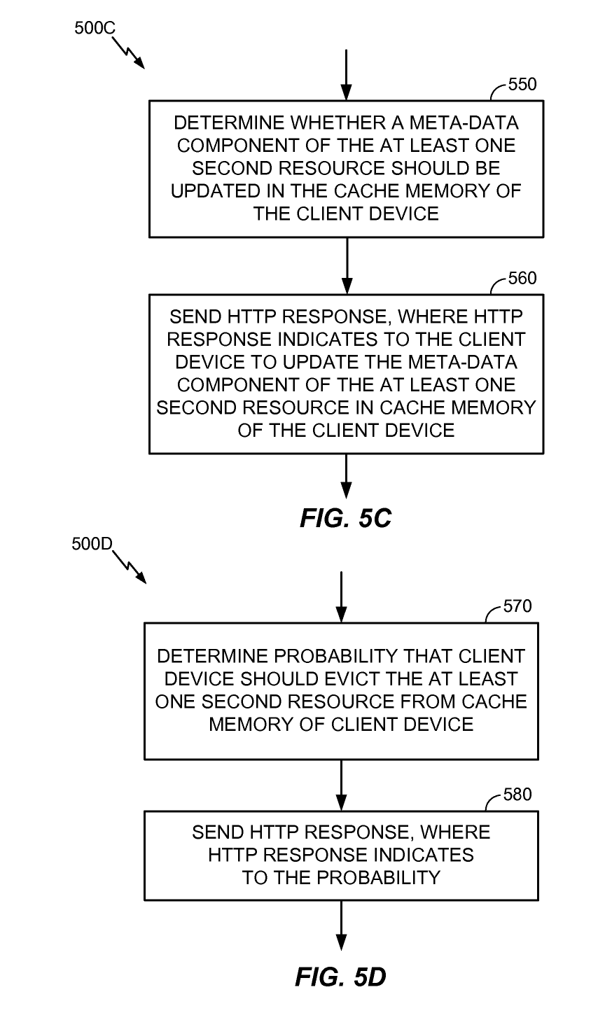

FIGS. 5A-5D illustrate various optional processes, performed by a server (e.g., web server 106 and/or web server 204), for cooperative management of cache memory of a client device in an HTTP session 100. For example, process 500A may be performed by a web server, such as web server 106, in addition to, or in lieu of process blocks 320 and 330 of process 300. In particular, process block 510 includes identifying, by the web server 106, one or more additional resource not included in the identification meta-data that are needed (or will be needed) by the client device for rendering the current web page. In response to determining that there are indeed one or more additional resources needed by the client device 102, process block 520 includes pushing only those resources to the client device 102 that web server 106 determines are not already included in the cache memory 108 of the client device 102.

In another example, process 500B of FIG. 5B may be performed by a web server, such as web server 106, in addition to, or in lieu of process blocks 320 and 330 of process 300. In particular, process block 530 includes determining, by the web server 106, whether the at least one second resource indicated in the identifying meta-data of the HTTP request should be updated in the cache memory 108 of the client device. In one embodiment, determining whether a resource should be updated may be based on an age of the resource (i.e., age of the resource contained in cache memory 108). In response to determining that there are indeed one or more resources at the client device 102 that need to be updated, process block 540 includes pushing only the updated resources to the client device 102 that web server 106 determines are in need of updating.

FIG. 5C illustrates another optional process 500C that may be performed by a web server, such as web server 106, in addition to, or in lieu of process blocks 320 and 330 of process 300. In particular, process block 550 includes determining, by the web server 106, whether a meta-data component of the at least one second resource identified in the identification meta-data of HTTP request 114 should be updated in the cache memory 108 of the client device 102. Thus, each resource included in the cache memory 108 may include both a meta-data component and a content component. The content component may correspond to the resource itself, such as an image or a video, whereas the meta-data component corresponds to information identifying the content component, such as its path, location, age, expiration, etc. In response to determining that at least one of the meta-data components should be updated, process block 560 includes sending the HTTP response, by the web server 106, where the HTTP response indicates to the client device 102 to update the meta-data component of the stored resource. As will be discussed below, the client device 102 may then proceed with initiating an update of the meta-data component. Accordingly, process 500C allows for a web server to ensure needed resources stored in the cache memory of a client device remain “fresh”, while reducing the overhead of a client device, by helping prevent the client device from performing unnecessary updates of resources.

FIG. 5D illustrates yet another optional process 500D that may be performed by a web server, such as web server 106, in addition to, or in lieu of process blocks 320 and 330 of process 300. In particular, process block 570 includes determining, by the web server 106, a probability that the client device should evict the at least one second resource identified in the HTTP request 114. In one embodiment, the probability may be determined based on an age of the resource contained in the cache memory 108 (e.g., the older the resource the higher the probability that it may be evicted). Process block 580 then includes sending the HTTP response 116 to the client device 102, where the HTTP response 116 not only identifies which resources 109 to evict, but also an respective probability eviction of that resource should be performed by the client device 102. As will be discussed below, the client device 102 may compare the received probability with a probability threshold to determine whether to actually evict the resource from cache memory 108.

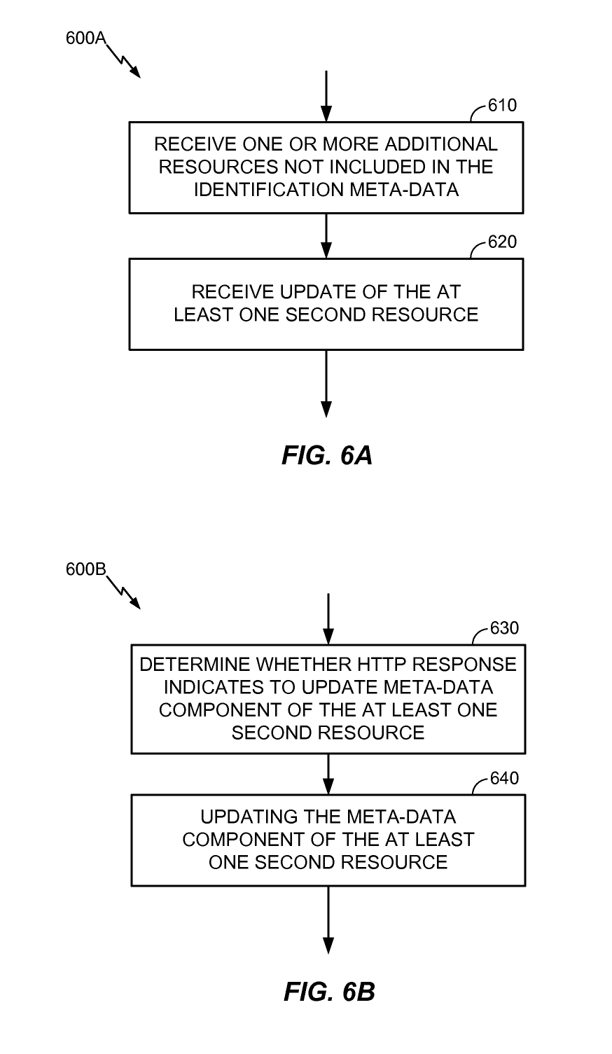

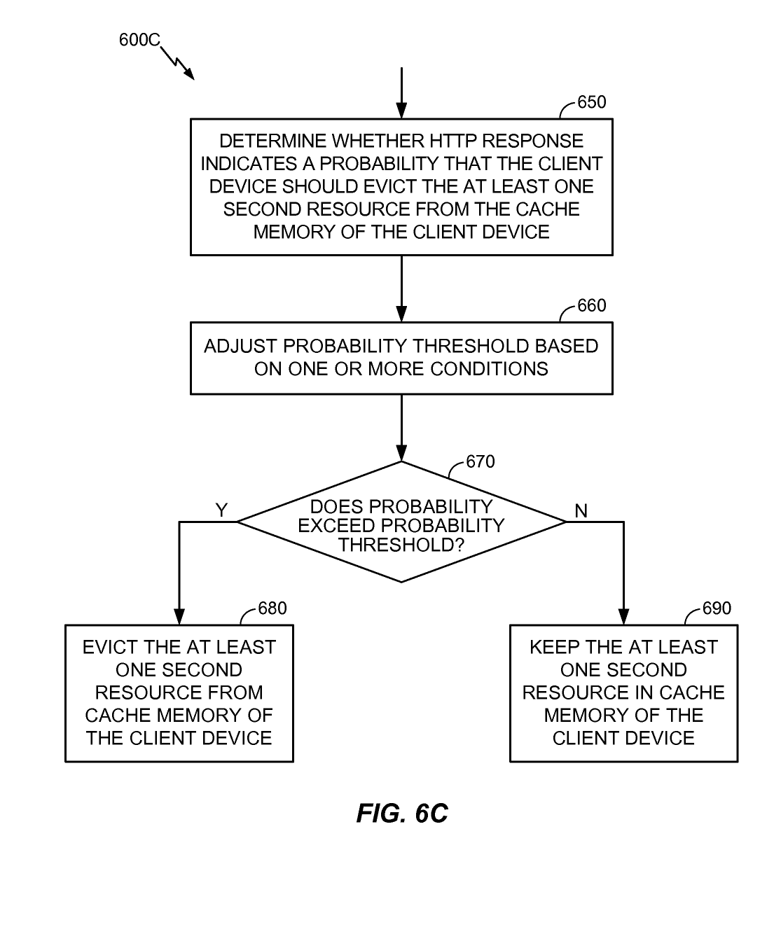

FIGS. 6A-6C illustrate various optional processes, performed by a client device (e.g., client device 102 and/or client device 202), for cooperative management of cache memory of a client device in an HTTP session.

For example, process 600A may be performed by a client device, such as client device 102, in addition to, or in lieu of process blocks 440 and 450 of process 400. In particular, process block 610 includes receiving from the web server 106, one or more additional resource not already included in the cache memory 108 that are needed (or will be needed) by the client device 102 for rendering the current web page. Similarly, in process block 620, client device 102 may receive an update of the at least one resource already included in cache memory 108.

FIG. 6B illustrates another optional process 600B that may be performed by a client device, such as client device 102, in addition to, or in lieu of process blocks 440 and 450 of process 400. In particular, process block 630 includes determining, by the client device 102, whether the received HTTP response 116 indicates to update the meta-data component of the at least one second resource identified in the HTTP request 114. That is, the HTTP response 116 may indicate to the client device 102 to update a meta-data component of a resource 109 already stored in cache memory 108, without the need to re-obtain (e.g., download) the entire resource (including the content component). In response to receiving the HTTP response 116, process block 640 then includes updating the meta-data component of the resource identified in the HTTP response 116.

FIG. 6C illustrates yet another optional process 600C that may be performed by a client device, such as client device 102, in addition to, or in lieu of process blocks 440 and 450 of process 400. In particular, process block 650 includes determining, by the client device 102, whether the received HTTP response 116 indicates a probability that the client device should evict the at least one second resource identified in the HTTP request 114. In process block 660, client device 102 adjusts a probability threshold based on one or more conditions. In decision block 670, client device 102 compares the received probability with a respective threshold in order to determine whether to evict the at least one second resource (i.e., process block 680) or to keep the at least one second resource in cache memory 108 (i.e., process block 690). Thus, process block 680 includes evicting the at least one second resource from the cache memory of the client device if the received probability exceeds the probability threshold, while process block 690 includes keeping the at least one second resource in the cache memory if the received probability does not exceed the probability threshold.

In certain implementations, the size of the cache memory 108 allocated by client device 102 may be limited. Thus, cache memory 108 may have maximum size that is the maximum amount of memory storage that cache memory 108 can consume and a current size that is the amount of memory stored current consumed by the case memory (based on the amount and size of resources 109 currently stored in cache memory 108). Thus, in one embodiment, process block 660 of adjusting the probability threshold may be based on either the maximum size of the cache memory 108 and/or the current size of cache memory 108. By way of example, as the current size of cache memory 108 increases and approaches that of the maximum size, client device 102 may decrease the probability threshold to increase the likelihood that one or more resources will be evicted from the cache memory 108. Similarly, as a resource stored in cache memory becomes older, client device 102 may decrease the probability threshold to increase the likelihood that older resources will be evicted.

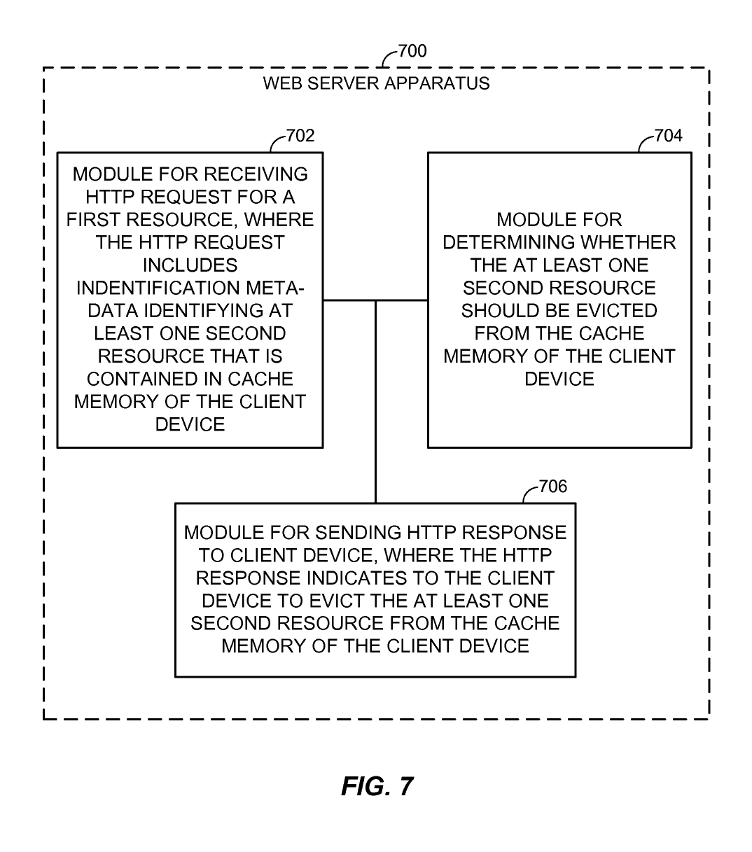

FIG. 7 is a simplified block diagram illustrating several sample aspects of components that may be employed in web server apparatus 700 configured to support cooperative management of cache memory of a client device in an HTTP session. FIG. 7 illustrates web server apparatus 700 represented as a series of interrelated functional modules. A module for receiving an HTTP request for a first resource 702 may correspond at least in some aspects to, for example, a communication device 222 as discussed above with reference to FIG. 2. A module for determining whether the at least one second resource should be evicted from the cache memory of the client device 704 may correspond at least in some aspects to, for example, a processing system 228 as discussed above with reference to FIG. 2. A module for sending the HTTP response to the client device 1306 may correspond at least in some aspects to, for example, a processing system 228 in conjunction with a communication device 222 as discussed above with reference to FIG. 2.

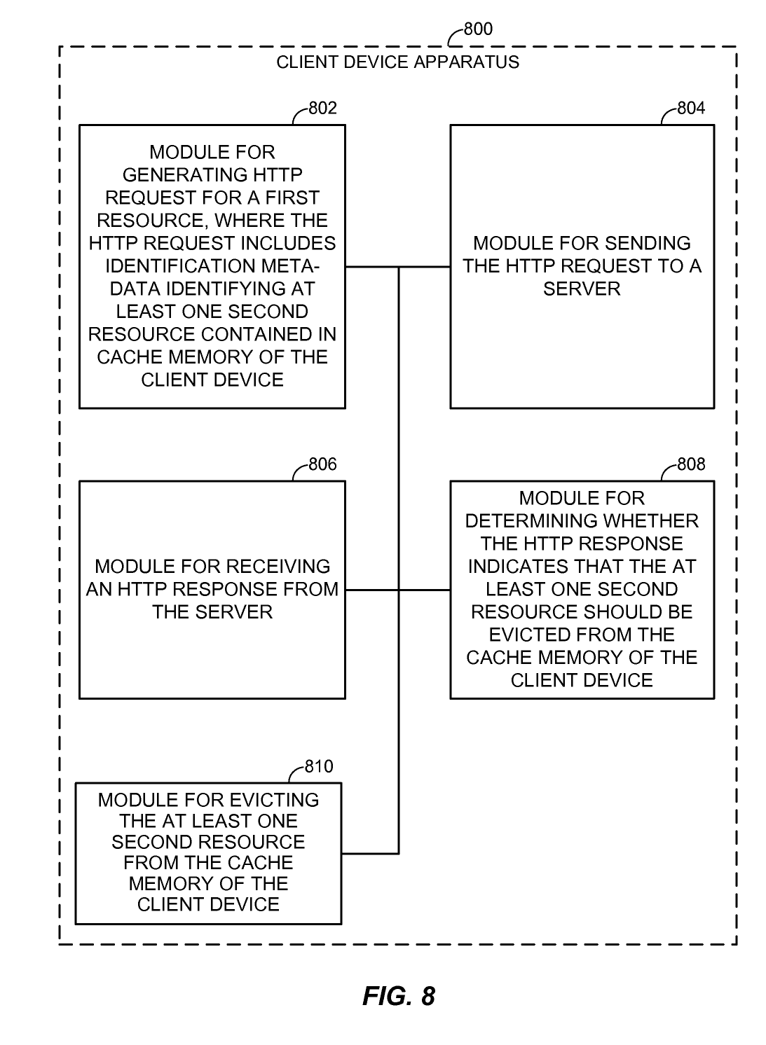

FIG. 8 is a simplified block diagram illustrating several sample aspects of components that may be employed in a client device apparatus 800 configured to support cooperative management of cache memory of the client device in an HTTP session. FIG. 8 illustrates client device apparatus 800 represented as a series of interrelated functional modules. A module for generating an HTTP request for a first resource 802 may correspond at least in some aspects to, for example, a processing system 212 as discussed above with reference to FIG. 2. A module for sending the HTTP request to a server 804 as well as a module for receiving an HTTP response from the server 806 may both correspond at least in some aspects to, for example, communication device 206, as discussed above with reference to FIG. 2. A module for determining whether the HTTP response indicates that at least one resource should be evicted 808 and a module for evicting the at least one second resource 810 may both correspond at least in some aspects to, for example, processing system 212.

The functionality of the modules of FIGS. 7 and 8 may be implemented in various ways consistent with the teachings herein. In some designs, the functionality of these modules may be implemented as one or more electrical components. In some designs, the functionality of these blocks may be implemented as a processing system including one or more processor components. In some designs, the functionality of these modules may be implemented using, for example, at least a portion of one or more integrated circuits (e.g., an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it will be appreciated that a given subset (e.g., of an integrated circuit and/or of a set of software modules) may provide at least a portion of the functionality for more than one module.

In addition, the components and functions represented by FIGS. 7 and 8, as well as other components and functions described herein, may be implemented using any suitable means. Such means also may be implemented, at least in part, using corresponding structure as taught herein. For example, the components described above in conjunction with the “module for” components of FIGS. 7 and 8 also may correspond to similarly designated “means for” functionality. Thus, in some aspects one or more of such means may be implemented using one or more of processor components, integrated circuits, or other suitable structure as taught herein.

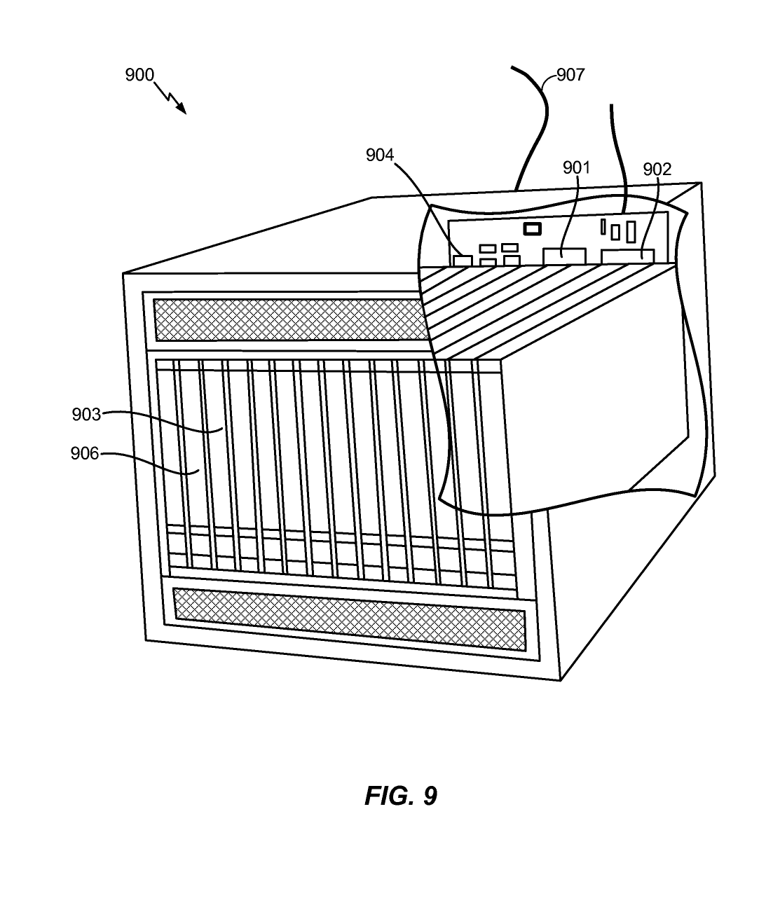

FIG. 9 is an example server 900 configured to support cooperative management of cache memory of the client device in an HTTP session. The various embodiments discussed herein may be implemented on any of a variety of commercially available server devices, such as server 900 illustrated in FIG. 9. In an example, the server 900 may correspond to one example configuration of the web server 106 and/or web server 204 described above. In FIG. 9, the server 900 includes a processor (e.g., processing unit) 901 coupled to volatile memory 902 and a large capacity nonvolatile memory, such as a disk drive 903. The server 900 may also include a floppy disc drive, compact disc (CD) or DVD disc drive 906 coupled to the processor 901. The server 900 may also include network access ports 904 coupled to the processor 901 for establishing data connections with a network 907, such as a local area network coupled to other broadcast system computers and servers or to the Internet. In context with FIG. 2, it will be appreciated that the server 900 of FIG. 9 illustrates one example implementation of the apparatus 204, wherein transmitter 224 and/or receiver 226 corresponds to the network access ports 904 used by the server 900 to communicate with the network 907, the processing system 228 corresponds to the processor 901, and the memory component 230 corresponds to any combination of the volatile memory 902, the disk drive 903 and/or the disc drive 906.

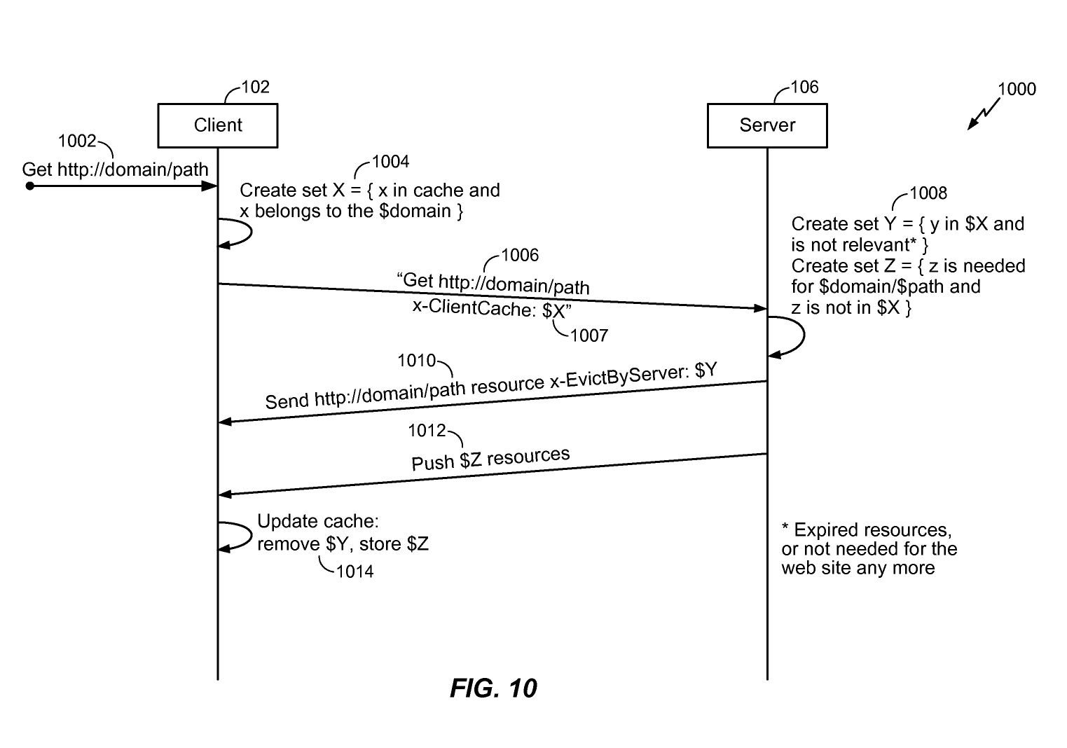

FIG. 10 is an example message flow procedure between a client device 102 and a web server 106 in an HTTP session for cooperative management of cache memory of the client device. As shown in FIG. 10, client device 102 may receive a GET HTTP message 1002 from an application, such as a web browser included in client device 102. As further shown, the GET HTTP message 1002 includes a domain and path of a requested resource. Next, client device 102 may create a set X 1004 of at least one second resources that are contained in cache memory of client device 102 and also belong to the same domain as indicated in the GET HTTP message 1002. Client device 102 then sends the GET HTTP message including the domain 1006 as well as identifying meta-data 1007 that identifies the resources included in set X 1004. Upon receipt of the GET HTTP message at web server 106, the web server 106 may generate one or more sets of indicators to send to the client device 102 and/or sets of resources to push to the client device 102. For example, web server 106 may generate a set Y of indicators that indicate whether one or more of the resources included in set X 1004 are no longer relevant and thus, no longer needed for the current web site. Web server 106 may then send an HTTP header 1010 back to the client device 102, where the HTTP header 1010 indicates which, if any, or the resources to evict from the cache memory of client device 102.

Web server 106 may also generate a set Z of resources that are not already included in the cache memory of client device 102, but yet they are needed for the web site indicated in the domain and path 1006. Thus, web server may then push the set Z of resources 1012 to client device 102. Client device 102 may then update the cache memory of client device 102 by removing (i.e., evicting) references indicated in set Y and storing the pushed resources of set Z.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on.

In view of the descriptions and explanations above, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Accordingly, it will be appreciated, for example, that an apparatus or any component of an apparatus may be configured to (or made operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

Moreover, the methods, sequences, and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor (e.g., cache memory).

Accordingly, it will also be appreciated, for example, that certain aspects of the disclosure can include a non-transitory computer-readable medium embodying a method for cooperative management of cache memory of the client device as discussed above with reference to processes 300, 400, 500A, 500B, 500C, 500D, 600A, 600B, and/or 600C.

While the foregoing disclosure shows various illustrative aspects, it should be noted that various changes and modifications may be made to the illustrated examples without departing from the scope defined by the appended claims. The present disclosure is not intended to be limited to the specifically illustrated examples alone. For example, unless otherwise noted, the functions, steps, and/or actions of the method claims in accordance with the aspects of the disclosure described herein need not be performed in any particular order. Furthermore, although certain aspects may be described or claimed in the singular, the plural is contemplated unless limitation to the singular is explicitly stated.

What is claimed is:

1. A method of cooperative management of cache memory of a client device in a Hypertext Transfer Protocol (HTTP) session, the method comprising:
receiving an HTTP request at a server from the client device for a first resource, wherein the HTTP request includes identification meta-data to identify at least one second resource that is contained in the cache memory of the client device;
determining, by the server, whether the at least one second resource identified in the identification meta-data of the HTTP request should be evicted from the cache memory of the client device; and
sending an HTTP response to the client device, wherein the HTTP response indicates to the client device to evict the at least one second resource from the cache memory of the client device in response to determining that the at least one second resource should be evicted.

2. The method of claim 1, wherein sending the HTTP response includes sending an HTTP header to the client device that indicates to the client device that the at least one second resource should be evicted from the cache memory of the client device.

3. The method of claim 1, wherein receiving the HTTP request at the server comprises receiving an HTTP GET message for the first resource.

4. The method of claim 1, further comprising determining, by the server, a probability that the client device should evict the at least one second resource from the cache memory of the client device, wherein the HTTP response indicates the probability.

5. The method of claim 1, further comprising:
identifying, by the server, one or more additional resources not included in the identification meta-data in response to the HTTP request; and
pushing, by the server, the one or more additional resources to the client device.

6. The method of claim 1, further comprising:
determining, by the server, whether the at least one second resource identified in the identification meta-data should be updated in the cache memory of the client device; and
pushing, by the server, an update of the at least one second resource to the client device in response to determining that the at least one second resource should be updated.

7. The method of claim 1, wherein the at least one second resource includes a content component and a meta-data component, the method further comprising determining, by the server, whether the meta-data component of the at least one second resource identified in the identification meta-data of the HTTP request should be updated in the cache memory of the client device, wherein the HTTP response indicates to the client device to update the meta-data component of the at least one second resource in the cache memory of the client device in response to determining that the meta-data component of the at least one second resource should be updated.

8. The method of claim 1, wherein the server is a web server, wherein the cache memory of the client device a browser cache memory of a web browser included on the client device, and wherein the first resource is a resource for use by the web browser for rendering a web page.

9. The method of claim 1, wherein determining, by the server, whether the at least one second resource identified in the identification meta-data of the HTTP request should be evicted from the cache memory of the client device is based on information that is not directly accessible to the client device.

10. The method of claim 1, wherein the at least one second resource is a resource selected from the group consisting of a web page, an image, and a video.

11. A method of cooperative management of cache memory of a client device in a Hypertext Transfer Protocol (HTTP) session, the method comprising:
generating an HTTP request, at the client device, for a first resource, wherein the HTTP request includes identification meta-data to identify at least one second resource that is contained in the cache memory of the client device;
sending the HTTP request to a server;
receiving an HTTP response from the server;
determining whether the HTTP response indicates that the at least one second resource should be evicted from the cache memory of the client device; and
evicting the at least one second resource from the cache memory of the client device in response to determining that the HTTP response indicates that the at least one second resource should be evicted.

12. The method of claim 11, wherein receiving the HTTP response from the server includes receiving an HTTP header that indicates that the at least one second resource should be evicted from the cache memory of the client device.

13. The method of claim 11, wherein the HTTP response indicates a probability, determined by the server, that the client device should evict the at least one second resource from the cache memory of the client device, the method further comprising evicting the at least one second resource in response to the probability.

14. The method of claim 13, wherein evicting the at least one second resource comprises evicting the at least one second resource if the probability exceeds a probability threshold.

15. The method of claim 14, further comprising adjusting the probability threshold in response to one or more conditions selected from the group consisting of: a current size of the cache memory, a maximum size of the cache memory, and an age of the at least one second resource.

16. The method of claim 11, further comprising receiving, from the server, one or more additional resources not included in the identification meta-data in response to the HTTP request.

17. The method of claim 11, further comprising receiving, from the server, an update of the at least one second resource in response to the HTTP request.

18. The method of claim 11, wherein the at least one second resource includes a content component and a meta-data component, and wherein the HTTP response, received from the server, indicates to the client device to update the meta-data component of the at least one second resource in the cache memory of the client device, the method further comprising, updating, by the client device, the meta-data component of the at least one second resource in response to the HTTP response indicating that the meta-data component should be updated.

19. The method of claim 11, wherein the server is a web server, wherein the cache memory of the client device a browser cache memory of a web browser included on the client device, and wherein the first resource is a resource for use by the web browser for rendering a web page.

20. A web server for cooperative management of cache memory of a client device in a Hypertext Transfer Protocol (HTTP) session, the web server comprising:
memory adapted to store program code; and
a processing unit coupled to the memory to access and execute instructions included in the program code to direct the web server to:
receive an HTTP request at the web server from the client device for a first resource, wherein the HTTP request includes identification meta-data to identify at least one second resource that is contained in the cache memory of the client device;
determine, by the web server, whether the at least one second resource identified in the identification meta-data of the HTTP request should be evicted from the cache memory of the client device; and
send an HTTP response to the client device, wherein the HTTP response indicates to the client device to evict the at least one second resource from the cache memory of the client device in response to determining that the at least one second resource should be evicted.

21. The web server of claim 20, wherein the instructions to send the HTTP response includes instructions to send an HTTP header to the client device that indicates to the client device that the at least one second resource should be evicted from the cache memory of the client device.

22. The web server of claim 20, further comprising instructions to direct the web server to determine a probability that the client device should evict the at least one second resource from the cache memory of the client device, wherein the HTTP response indicates the probability.

23. The web server of claim 20, wherein the at least one second resource includes a content component and a meta-data component, the program code further comprising instructions to direct the web server to determine whether the meta-data component of the at least one second resource identified in the identification meta-data of the HTTP request should be updated in the cache memory of the client device, wherein the HTTP response indicates to the client device to update the meta-data component of the at least one second resource in the cache memory of the client device in response to determining that the meta-data component of the at least one second resource should be updated.

24. A client device for cooperative management of cache memory of the client device in a Hypertext Transfer Protocol (HTTP) session with a web server, the client device comprising:
memory adapted to store program code; and
a processing unit coupled to the memory to access and execute instructions included in the program code to direct the client device to:
generate an HTTP request, at the client device, for a first resource, wherein the HTTP request includes identification meta-data to identify at least one second resource that is contained in the cache memory of the client device;
send the HTTP request to the web server;
receive an HTTP response from the web server;
determine whether the HTTP response indicates that the at least one second resource should be evicted from the cache memory of the client device; and
evict the at least one second resource from the cache memory of the client device in response to determining that the HTTP response indicates that the at least one second resource should be evicted.

25. The client device of claim 24, wherein the instructions to receive the HTTP response from the server includes instructions to receive an HTTP header that indicates that the at least one second resource should be evicted from the cache memory of the client device.

26. The client device of claim 24, wherein the HTTP response indicates a probability, determined by the server, that the client device should evict the at least one second resource from the cache memory of the client device, the program code further comprising instructions to evict the at least one second resource in response to the probability.

27. The client device of claim 24, wherein the instructions to evict the at least one second resource comprises instructions to evict the at least one second resource if the probability exceeds a probability threshold.

28. The client device of claim 27, wherein the program code further comprises instructions to adjust the probability threshold in response to one or more conditions selected from the group consisting of: a current size of the cache memory, a maximum size of the cache memory, and an age of the at least one second resource.

29. The client device of claim 24, wherein the at least one second resource includes a content component and a meta-data component, and wherein the HTTP response, received from the server, indicates to the client device to update the meta-data component of the at least one second resource in the cache memory of the client device, the program code further comprising instructions to update, by the client device, the meta-data component of the at least one second resource in response to the HTTP response indicating that the meta-data component should be updated.

30. The client device of claim 24, wherein the server is a web server, wherein the cache memory of the client device a browser cache memory of a web browser included on the client device, and wherein the first resource is a resource for use by the web browser for rendering a web page.
